(19) United States
(12) Patent Application Publication
(10) Pub. No.: US 2017/0345020 A1
(43) Pub. Date: Nov. 30, 2017

(54) AUTHENTICATION OF RETAILERS AND DISTRIBUTORS

(71) Applicant: Authenticate Me LLC, Purcellville, VA (US)

(72) Inventor: Carlos Manuel MAZA, Purcellville, VA (US)

(21) Appl. No.: 15/607,015

(22) Filed: May 26, 2017

Related U.S. Application Data
(60) Provisional application No. 62/342,554, filed on May 27, 2016.

(51) Int. Cl. G06Q 30/00; G06K 19/10; G06Q 30/02; G06F 17/30; G06Q 30/06

(52) U.S. Cl. CPC G06Q 30/0185; G06Q 30/0207; G06F 17/30861; G06K 19/10; G06Q 30/06

(57) ABSTRACT

Methods and systems for authentication of retailers and distributors are disclosed. In one example, a purchaser can authenticate a retailer at the time of purchase. The method includes scanning an authentication code on a product at the retailer. A retailer code is obtained to identify the retailer. The authentication information is transmitted to an authentication server. The authentication information includes at least one of the authentication code or the retailer code. A response is received from the authentication server indicating the retailer authentication.

### CROSS-REFERENCE TO RELATED APPLICATIONS

The present application for patent claims the benefit of Provisional Patent Application No. 62/342,554 entitled “AUTHENTICATION OF RETAILERS AND DISTRIBUTORS” filed on May 27, 2016, pending, and assigned to the assignee hereof and hereby expressly incorporated herein by reference in its entirety.

### TECHNICAL FIELD

The various aspects and embodiments described herein generally relate to secure transactions in retail sales and more particularly, to providing authentication of retailers and distributors of products being sold to consumer purchasers to provide a confidence level to the purchasers at the time of sale.

### BACKGROUND

Retail markets are often world wide for many products and with the frequency of travel purchasers may be buying products in foreign nations where they may not be familiar with the retailers. Additionally, as the distribution chains for products become more complex it is possible for both unauthorized retailers to provide legitimate products and for unauthorized distributors to obtain products out of the designated supply chains from the manufactures. This can facilitate product counterfeiting and product theft since there is an avenue for illegally obtained products to be purchased by consumers. Additionally, this also can cause interference with authorized retailers and limits the market control by the manufacturer.

Internet purchases also provide a potential source for unauthorized retailers to provide products to a purchaser without an easy way for the purchaser to verify that both the products are authentic and the retailer is authorized to sell the products.

### SUMMARY

The following presents a simplified summary relating to one or more aspects and/or embodiments disclosed herein. As such, the following summary should not be considered an extensive overview relating to all contemplated aspects and/or embodiments, nor should the following summary be regarded to identify key or critical elements relating to all contemplated aspects and/or embodiments or to delineate the scope associated with any particular aspect and/or embodiment. Accordingly, the following summary has the sole purpose to present certain concepts relating to one or more aspects and/or embodiments relating to the mechanisms disclosed herein in a simplified form to precede the detailed description presented below.

According to one exemplary aspect, a method for a purchaser to authenticate a retailer at the time of purchase is provided. The method for authentication of a retailer at the place of purchase includes scanning an authentication code on a product at the retailer; obtaining a retailer code to identify the retailer; transmitting authentication information including at least one of the authentication code or the retailer code to an authentication server; and receiving a response from the authentication server indicating the retailer authentication.

Other objects and advantages associated with the aspects and embodiments disclosed herein will be apparent to those skilled in the art based on the accompanying drawings and detailed description.

### BRIEF DESCRIPTION OF THE DRAWINGS

A more complete appreciation of the various aspects and embodiments described herein and many attendant advantages thereof will be readily obtained as the same becomes better understood by reference to the following detailed description when considered in connection with the accompanying drawings which are presented solely for illustration and not limitation, and in which:

FIG. 1A is an illustration of a system diagram for a retail implementation.

FIG. 1B is an illustration of a system diagram for an online implementation.

FIG. 1C is an illustration of a system diagram for a distribution implementation.

FIG. 2A is an illustration of an authentication device in the form of a smart phone.

FIG. 2B is an illustration of an authentication device in the form of a dedicated scanning device.

FIG. 3 is an illustration of internal functional blocks of an authentication device.

FIG. 4A is an illustration of a flowchart for a retail implementation.

FIG. 4B is an illustration of a flowchart for an online implementation.

FIG. 4C is an illustration of a flowchart for a distribution implementation.

FIG. 5 is an illustration of an authentication server.

FIG. 6 is an illustration of a flowchart for a server implementation.

FIG. 7 is an illustration of a flowchart for a voting implementation.

FIG. 8 is an illustration of a flowchart for a voting server implementation.

### DETAILED DESCRIPTION

Various aspects and embodiments are disclosed in the following description and related drawings to show specific examples relating to exemplary aspects and embodiments. Alternate aspects and embodiments will be apparent to those skilled in the pertinent art upon reading this disclosure, and may be constructed and practiced without departing from the scope or spirit of the disclosure. Additionally, well-known elements will not be described in detail or may be omitted so as to not obscure the relevant details of the aspects and embodiments disclosed herein.

The word “exemplary” is used herein to mean “serving as an example, instance, or illustration.” Any embodiment described herein as “exemplary” is not necessarily to be construed as preferred or advantageous over other embodiments. Likewise, the term “embodiments” does not require that all embodiments include the discussed feature, advantage or mode of operation.

The terminology used herein describes particular embodiments only and should not be construed to limit any embodiments disclosed herein. As used herein, the singular forms “a,” “an,” and “the” are intended to include the plural forms as well, unless the context clearly indicates otherwise. Those skilled in the art will further understand that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Further, many aspects are described in terms of sequences of actions to be performed by, for example, elements of a computing device. Those skilled in the art will recognize that various actions described herein can be performed by specific circuits (e.g., an application specific integrated circuit (ASIC)), by program instructions being executed by one or more processors, or by a combination of both. Additionally, these sequence of actions described herein can be considered to be embodied entirely within any form of computer-readable storage medium having stored therein a corresponding set of computer instructions that upon execution would cause an associated processor to perform the functionality described herein. Thus, the various aspects described herein may be embodied in a number of different forms, all of which have been contemplated to be within the scope of the claimed subject matter. In addition, for each of the aspects described herein, the corresponding form of any such aspects may be described herein as, for example, “logic configured to” perform the described action.

The systems and methods described herein provide means to empower a manufacturer's consumer base to verify they are purchasing authentic products from authorized retailers and provides data to the manufacturer that can ensure the security of its supply chain. This aspect of crowd sourcing supply chain security can be used in a variety of industries and for any products that have retail distribution.

For example, a consumer walks into an airport electronics shop and looks over the displays of all the audio headset brands. He sees a pair of headphones, but wonders if they are authentic or not. He ponders on the decision to buy or wait until he can get to a known retailer in the city of his destination. His indecisiveness is fueled by not knowing if the retailer is actually selling authentic headphones or even if the store is an authorized reseller of the product, in which case the warranty may not be honored by the manufacturer.

One aspect of the disclosed aspects is to provide an “Authenticate Me”™ Application (App) to allow a consumer to scan an authentication code (e.g., QR code, bar code, RFID, etc.) posted on the product and also to obtain the retailer code. Then, with an active internet connection (e.g., WAN data, Wi-Fi, etc.) on an authentication device (e.g., smart phone, tablet, dedicated device, etc.) the consumer can confirm if the retailer is actually an authorized seller of the product.

Retailers may participate in the process and can post their participation in the “Authenticate Me”™ program. The “Authenticate Me”™ process/devices can allow the manufacturer and retailer to utilize crowdsourcing application (“app”) to collect data on consumers' purchasing habits. The “Authenticate Me”™ process/devices can allow manufacturers to identify potential unauthorized or gray market resellers of their products. The “Authenticate Me”™ process/devices can allow manufacturers to evaluate buy/sell patterns of their retailers to ensure they are buying from source suppliers and within their purchased inventory. Participation by manufacturers and retailers will assist in identifying unscrupulous sellers and focus security of the supply chain and product integrity efforts. The consumer can feel empowered knowing they are buying authentic products and sales could increase at retailers who display their participation.

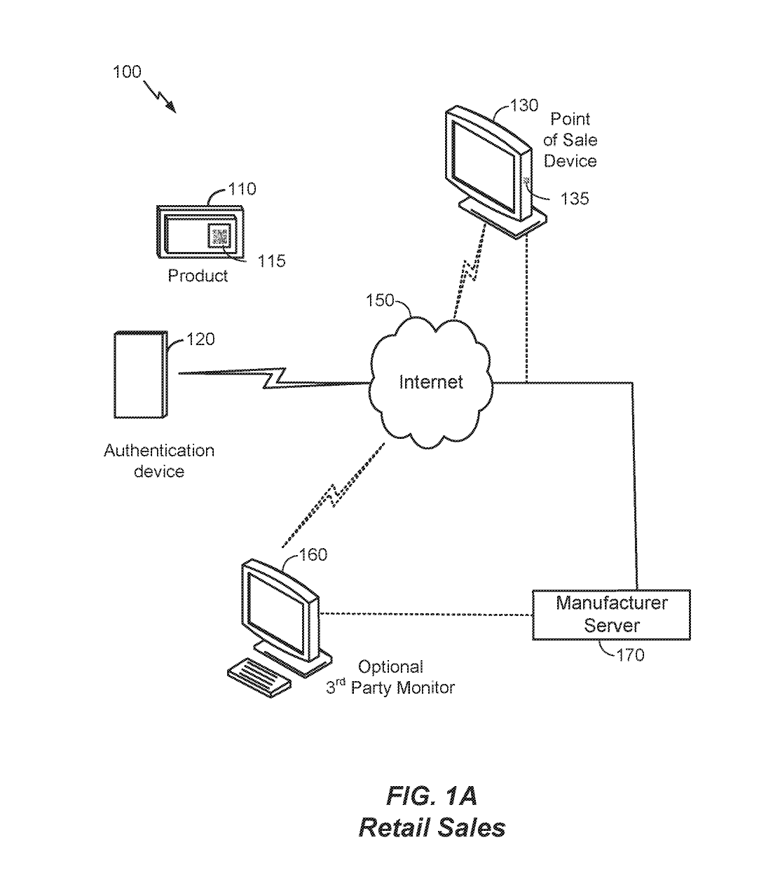

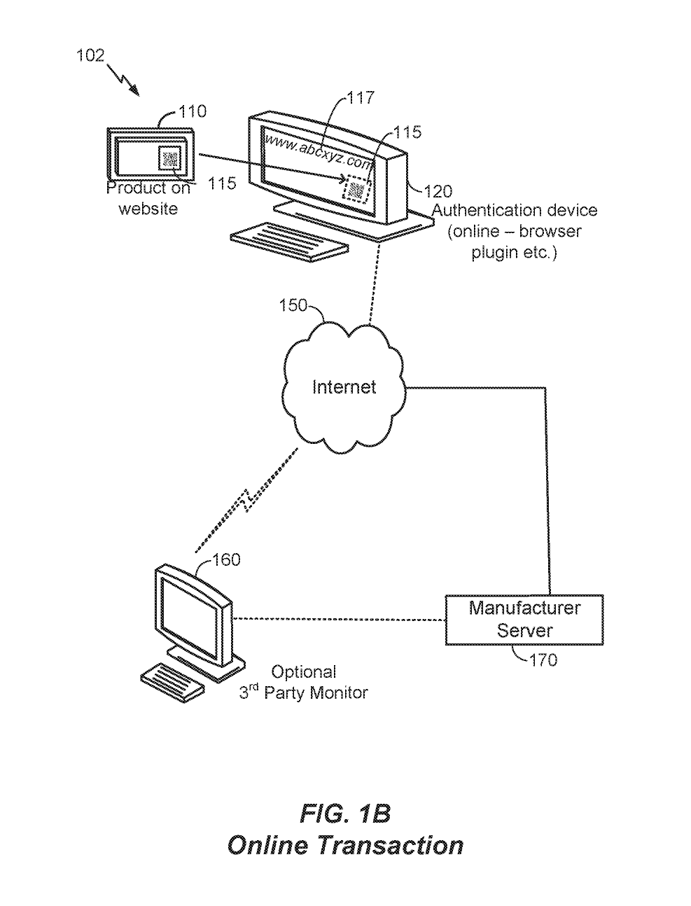

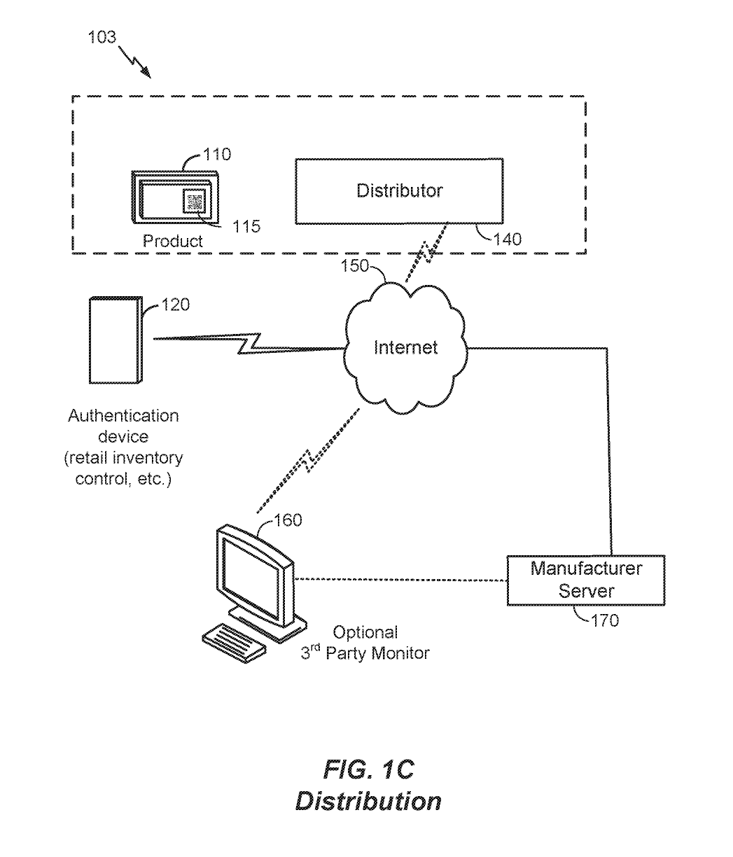

FIG. 1A illustrates a high-level system architecture 100 in a retail aspect in accordance with various aspects. The system 100 contains an authentication device 120 (e.g., smart phone, tablet, dedicated device, etc.) in communication with the Internet 150. Additionally, a product 110 includes an authentication code 115 (e.g., QR code, bar code, RF-ID tag, etc.). The authentication device 120 can scan the authentication code 115 and then the authentication device 120 can obtain a retailer code 135 (e.g., QR code, bar code, RF-ID tag, etc.) at a point of sale device 130, which may be connected to the Internet 150 wirelessly and/or by a hardwired connection. Alternatively, the authentication device 120 can use its location information (e.g., available by GPS, Wi-Fi, etc.) to verify the retailer and this location information can be used as the retailer code 135 or can be included as additional information as part of the authentication information. Additional information, such as the authentication device IP address, visible access points (APs), cellular network, and any other information identification and/or location information available to the authentication device 120 can optionally be included as part of the authentication information to aid in verifying the retailer. The authentication information is transmitted to an authentication server (e.g., a manufacturer server 170, a 3^{rd} party server 160 or both). Based on the information received from the authentication server, the authentication device 120 can notify a purchaser as to whether the retailer is authorized or not authorized to sell the product 110. Additionally, the authentication server (or additional server) can provide additional information to the authentication device 120 such as incentive (e.g. extended warranty), advertisement, discount, etc.

The Internet 150 includes a number of routing agents and processing agents (not shown in FIG. 1A for the sake of convenience). The Internet 150 is a global system of interconnected computers and computer networks that uses a standard Internet protocol suite (e.g., the Transmission Control Protocol (TCP) and IP) to communicate among disparate devices/networks. TCP/IP provides end-to-end connectivity specifying how data should be formatted, addressed, transmitted, routed and received at the destination.

In FIG. 1A, the point of sale device 130 may be a computer, such as a desktop or personal computer (PC), retail cash register or any device for conducting retail transactions, and is shown as connecting to the Internet 150 directly (e.g., over an Ethernet connection or Wi-Fi or 802.11-based network). The point of sale device 130 may have a wired connection to the Internet 150, such as a direct connection to a modem or router, which, in an example, can correspond to the access point (e.g., for a Wi-Fi router with both wired and wireless connectivity). Alternatively, rather than being connected to the access point and the Internet 150 over a wired connection, the authentication device 120 may be connected to the access point over air interface or another wireless interface, and access the Internet 150 over the air interface.

Referring to FIG. 1A, the manufacturer server 170 is shown as connected to the Internet 150. The manufacturer server 170 can be implemented as a plurality of structurally separate servers, or alternately may correspond to a single server. In various embodiments, the manufacturer server 170 may be optionally (as indicated by the dotted line) connected to a 3^{rd} party server 160 either through the internet or via another connection. Likewise, the 3^{rd} party server 160 is shown as connected to the Internet 150. The 3^{rd} party server 160 can be implemented as a plurality of structurally separate servers, or alternately may correspond to a single server. As discussed in the foregoing the authentication server can be the manufacturer server 170, a 3^{rd} party server 160 or a combination of both. To simplify the description herein, the authentication server, will be discussed from the perspective of the manufacturer server 170, although the various aspects of the invention are not limited to this configuration.

In accordance with various aspects, FIG. 1B is an illustration of a system diagram for an online implementation. In general, the system 102 shown in FIG. 1B may include various components that are the same and/or substantially similar to the system 100 shown in FIG. 1A, which was described in greater detail above, so repetition of the description will not be provided herein. In this configuration, rather than a purchase at a physical retailer, the purchase can occur online. In this configuration, the authentication device 120 can be a computer (e.g., desktop, laptop, smartphone, tablet, etc.) having an application running on the computer, a browser plugin, etc. that can access the online retailer via a browser or dedicated shopping application. In this configuration, the product 110 can be viewed as an image online and an authentication code 115 (e.g., QR code, bar code, etc.) may be displayed on the image or associated with the image. The authentication device 120 can scan the authentication code 115 (e.g., acquired using the application or browser plugin). The authentication device 120 can scan the retailer code and since the retailer is an online retailer and the retailer code can be a website Uniform Resource Locator (URL) 117 associated with the online retailer. The authentication device 120 can then use this retailer code along with the authentication code 115 as authentication information to be transmitted to an authentication server. As discussed above, the authentication information is transmitted to an authentication server (e.g., a manufacturer server 170, a 3^{rd} party server 160 or both). Based on the information received from the authentication server, the authentication device 120 can notify the purchaser as to whether the online retailer is authorized or not authorized to sell the product 110. Additionally, as discussed above, the authentication server (or additional server) can provide additional information to the authentication device 120 such as incentive (e.g. extended warranty), advertisement, discount, etc.

In accordance with various aspects, FIG. 1C is an illustration of a system diagram for a distribution implementation. In general, system 103 shown in FIG. 1C may include various components that are the same and/or substantially similar to the system 100 shown in FIG. 1A, which was described in greater detail above, so repetition of the description will not be provided herein. In this configuration, rather than a retail purchase, the authentication can be performed in the distribution chain. In this configuration, the authentication device 120 can be a computer (e.g., desktop, laptop, smartphone, tablet, dedicated inventor control apparatus, etc.) and can be used to log deliveries, inventory, and related functions. In this configuration, the product 110 can be part of a larger package including multiple products or individual packages. An authentication code 115 (e.g., QR code, bar code, RF-ID tag, etc.) may be displayed on each individual product package and/or may be displayed on the packaging for a larger group of packages. For example, a manufacturer may package individual products in a larger package that may contain the authentication code 115. The authentication code 115 in the larger package configuration may be the same or different as the individual product authentication code. Regardless of the specific implementation details, the process can be similar, in that the authentication device 120 can scan the authentication code 115. The authentication device 120 can scan the distributor code, which may also be included in the larger package configuration, or may be a code, or other identification information associated with a distributor 140. The authentication device 120 can then use this distributor code along with the authentication code 115 as authentication information to be transmitted to an authentication server. As discussed above, the authentication information is transmitted to the authentication server (e.g., a manufacturer server 170, a 3rd party server 160 or both). Based on the information received from the authentication server, the authentication device 120 can notify the retailer as to whether the distributor 140 is authorized or not authorized to distribute the product 110. The distributor 140 may optionally transmit shipping information to the authentication server (e.g., a manufacturer server 170, a 3rd party server 160 or both), such as shipping information (e.g., retailer destination, quantity shipped, and the like) to aid the authentication server in determining the integrity of the distribution chain. For example, to ensure that all the product shipped reached its designated destination as often theft or intentional diversion of product can be a source of legitimate product that is distributed to unauthorized retailers.

As discussed above, the “scanning” of the various codes is intended to be construed broadly as any way to obtain the relevant information. For example, the authentication device 120 may include one or more appropriate scanners or readers (optical, RF, cameras, lasers, etc.) that can read the RFID tag, barcode, QR code or any other device configured to detect the authentication code. Additionally, in some aspects, the “scanning” can include manual entry of data as the authentication code. Further, it will be appreciated that additional information obtained may be optionally included in the authentication information from various components on the authentication device 120 (e.g., Wi-Fi transceivers, GPS receivers, cameras, sensors, etc.). The additional information may aid in the authentication process. For example, even though the authentication code 115 and retailer code may indicate the retailer is authorize, location information (e.g., from the GPS, IP address, cellular network and/or Wi-Fi) may indicate that the retailer is not authentic. This could occur in situations where an unauthorized retailer may try to clone a code of an authorized retailer.

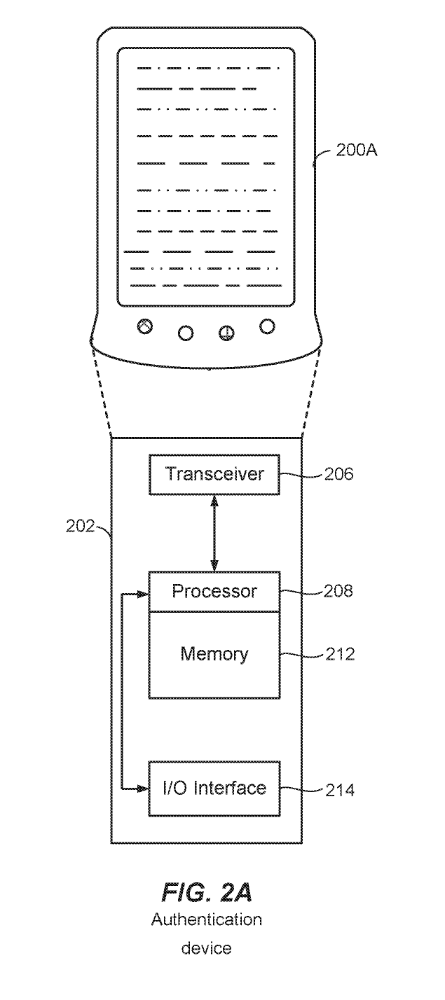

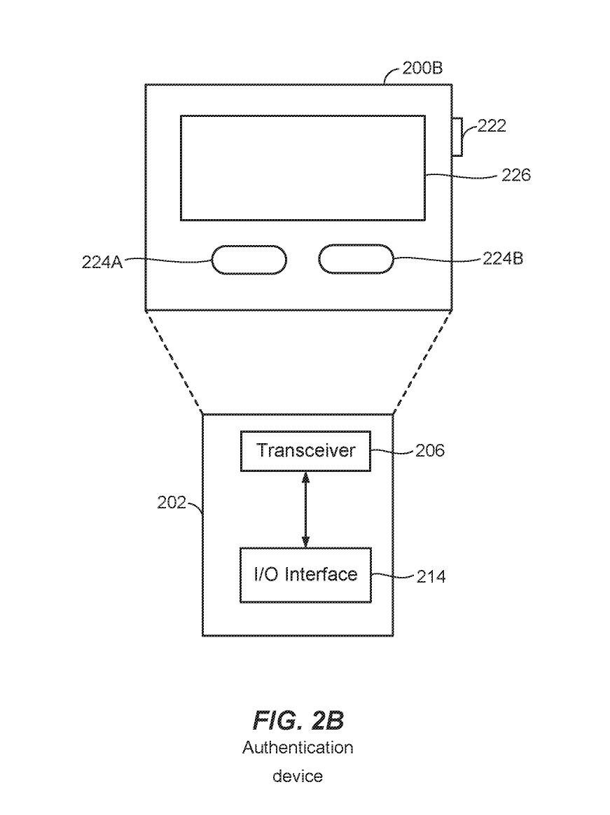

FIG. 2A illustrates a high-level example of an authentication device 200A in accordance with various aspects. While external appearances and/or internal components can differ significantly among authentication devices, most authentication devices will have some sort of user interface, which may comprise a display and a means for user input. Authentication devices without a user interface can be communicated with remotely over a wired or wireless network, such as air interface as illustrated FIGS. 1A-1C.

As shown in FIG. 2A, in an example configuration for the authentication device 200A, an external casing of authentication device 200A may be configured with a display and optionally various buttons, among other components, as is known in the art. The display may be a touchscreen display, in which case the control buttons may not be necessary. While not shown explicitly as part of authentication device 200A, the authentication device 200A may include one or more external antennas and/or one or more integrated antennas that are built into the external casing, including but not limited to Wi-Fi antennas, cellular antennas, satellite position system (SPS) antennas (e.g., global positioning system (GPS) antennas), and so on.

While internal components of authentication devices, such as authentication device 200A, can be embodied with different hardware configurations, a basic high-level configuration for internal hardware components is shown as platform 202 in FIG. 2A. The platform 202 can receive and execute software applications, data and/or commands transmitted over a network interface, such as air interface in FIGS. 1A-1C and/or a wired interface. The platform 202 can also independently execute locally stored applications. The platform 202 can include one or more transceivers 206 configured for wired and/or wireless communication (e.g., a Wi-Fi transceiver, a Bluetooth transceiver, a cellular transceiver, a satellite transceiver, a GPS or SPS receiver, etc.) operably coupled to one or more processors 208, such as a microcontroller, microprocessor, application specific integrated circuit (ASIC), digital signal processor (DSP), programmable logic circuit, or other data processing device, which will be generally referred to as processor 208. The processor 208 can execute application programming instructions within a memory 212 of the authentication device 200A. The memory 212 can include one or more of read-only memory (ROM), random-access memory (RAM), electrically erasable programmable ROM (EEPROM), flash cards, or any memory common to computer platforms. One or more input/output (I/O) interfaces 214 can be configured to allow the processor 208 to communicate with and control from various I/O devices such as the display, power button, control buttons, as illustrated, and any other devices, such as sensors, actuators, RF-ID tags, and the like associated with the authentication device 200A.

Accordingly, various aspects can include an authentication device (e.g., authentication device 200A) including the ability to perform the functions described herein. As will be appreciated by those skilled in the art, the various logic elements can be embodied in discrete elements, software modules executed on a processor (e.g., processor 208) or any combination of software and hardware to achieve the functionality disclosed herein. For example, transceiver 206, processor 208, memory 212, and I/O interface 214 may all be used cooperatively to load, store and execute the various functions disclosed herein and thus the logic to perform these functions may be distributed over various elements. Alternatively, the functionality could be incorporated into one discrete component. Therefore, the features of the authentication device 200A in FIG. 2A are to be considered merely illustrative and the authentication device 200A is not limited to the illustrated features or arrangement shown in FIG. 2A.

FIG. 2B illustrates a high-level example of an alternative authentication device 200B in accordance with various aspects. In general, the authentication device 200B shown in FIG. 2B may include various components that are the same and/or substantially similar to the authentication device 200A shown in FIG. 2A, which was described in greater detail above. As such, for brevity and ease of description, various details relating to certain components in the passive authentication device 200B shown in FIG. 2B may be omitted herein to the extent that the same or similar details have already been provided above in relation to the authentication device 200A illustrated in FIG. 2A.

The authentication device 200B shown in FIG. 2B may generally differ from the authentication device 200A shown in FIG. 2A in that the authentication device 200B may not have a general processor, internal memory, or certain other components. Instead, in various embodiments, the authentication device 200B may only include an I/O interface 214 which includes dedicated circuitry and/or processor or other suitable mechanisms that allow the authentication device 200B to perform only a dedicated portion of the scanning/authentication process. For example, in various embodiments, the I/O interface 214 associated with the authentication device 200B may include a barcode, Bluetooth interface, radio frequency (RF) interface, RFID tag, IR interface, NFC interface, or any other suitable I/O interface that can detect an authentication code. In some aspects, the authentication device 200B can be a dedicated device that works cooperatively with other devices (e.g., may use the wireless capabilities of a smartphone, computer, etc.) to interface to the Internet to perform the authentication process. The authentication device 200B may optionally include various other elements based on specific application design choices. For example, the authentication device 200B may include external scanning device 222 (e.g., optical sensor, RFID reader, camera, antenna, etc.), external button 224A and/or external button 224B to perform specific functions, access menu options, make selections, etc. Further, an optional display 226 can be provided to display information to a user.

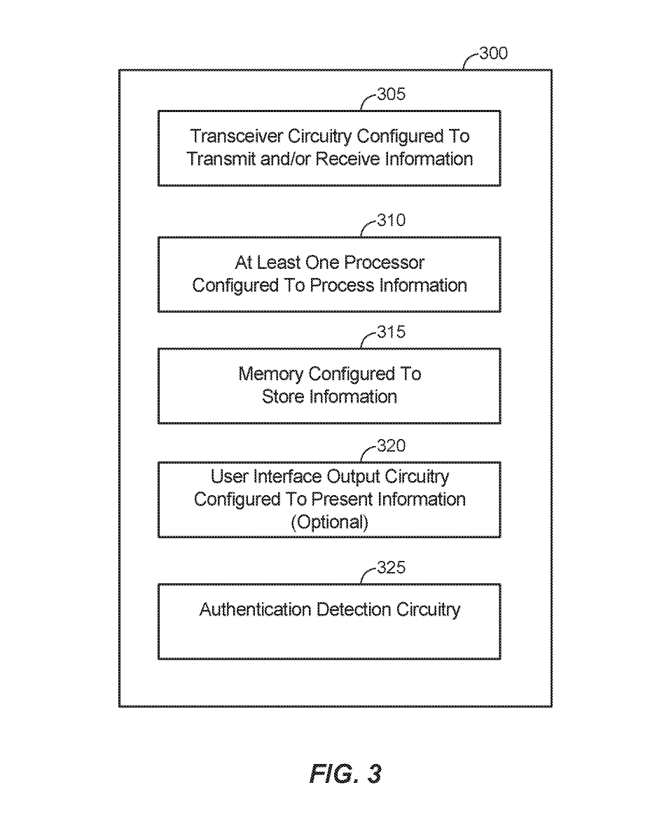

FIG. 3 illustrates an authentication device 300 that includes various structural components configured to perform functionality. The authentication device 300 can correspond to any of the authentication devices described in further detail above, including but not limited to any one or more of the authentication devices or other devices in the systems 100, 102, 103, shown in FIGS. 1A-1C, the authentication device 200A shown in FIG. 2A, the authentication device 200B shown in FIG. 2B, and so on. Accordingly, those skilled in the art will appreciate that the authentication device 300 shown in FIG. 3 can correspond to any electronic device configured to perform the authentication functions disclosed herein.

Referring to FIG. 3, the authentication device 300 includes transceiver circuitry configured to transmit and/or receive information 305. In an example, if the authentication device 300 corresponds to a wireless communications device (e.g., authentication device 200A), the transceiver circuitry configured to transmit and/or receive information 305 can include a wireless communications interface (e.g., Bluetooth, Wi-Fi, Wi-Fi Direct, Long-Term Evolution (LTE) Direct, etc.) such as a wireless transceiver and associated hardware (e.g., an RF antenna, a MODEM, a modulator and/or demodulator, etc.). In another example, the transceiver circuitry configured to transmit and/or receive information 305 can correspond to a wired communications interface (e.g., a serial connection, a USB or Firewire connection, an Ethernet connection through which the Internet 150 can be accessed, etc.). In a further example, the transceiver circuitry configured to transmit and/or receive information 305 can include sensory or measurement hardware by which the authentication device 300 can monitor a local environment associated therewith (e.g., an accelerometer, a temperature sensor, a light sensor, an antenna for monitoring local RF signals, etc.). The transceiver circuitry configured to transmit and/or receive information 305 can also include software that, when executed, permits the associated hardware of the transceiver circuitry configured to transmit and/or receive information 305 to perform the reception and/or transmission function(s) associated therewith. However, the transceiver circuitry configured to transmit and/or receive information 305 does not correspond to software alone, and the transceiver circuitry configured to transmit and/or receive information 305 relies at least in part upon structural hardware to achieve the functionality associated therewith.

Referring to FIG. 3, the authentication device 300 further includes at least one processor configured to process information 310. Example implementations of the type of processing that can be performed by the at least one processor configured to process information 310 includes but is not limited to performing determinations, establishing connections, making selections between different information options, performing evaluations related to data, interacting with sensors coupled to the authentication device 300 to perform measurement operations, converting information from one format to another and so on. For example, the at least one processor configured to process information 310 can include a general purpose processor, a DSP, an ASIC, a field programmable gate array (FPGA) or other programmable logic device, discrete gate or transistor logic, discrete hardware components, or any combination thereof designed to perform the functions described herein. A general purpose processor may be a microprocessor, but in the alternative, the at least one processor configured to process information 310 may be any conventional processor, controller, microcontroller, or state machine. The at least one processor configured to process information 310 may also be implemented as a combination of computing devices (e.g., a combination of a DSP and a microprocessor, a plurality of microprocessors, one or more microprocessors in conjunction with a DSP core, or any other such configuration). The at least one processor configured to process information 310 can also include software that, when executed, permits the associated hardware of the at least one processor configured to process information 310 to perform the processing function(s) associated therewith. However, the at least one processor configured to process information 310 does not correspond to software alone, and the at least one processor configured to process information 310 relies at least in part upon structural hardware to achieve the functionality associated therewith.

Referring to FIG. 3, the authentication device 300 further includes memory configured to store information 315. In an example, the memory configured to store information 315 can include at least a non-transitory memory and associated hardware (e.g., a memory controller, etc.). For example, the non-transitory memory included in the memory configured to store information 315 can correspond to RAM, flash memory, ROM, erasable programmable ROM (EPROM), EEPROM, registers, hard disk, a removable disk, a CD-ROM, or any other form of storage medium known in the art.

Referring to FIG. 3, the authentication device 300 further optionally includes user interface output circuitry configured to present information 320. In an example, the user interface output circuitry configured to present information 320 can include at least an output device and associated hardware. For example, the output device can include a video output device (e.g., a display screen, a port that can carry video information such as USB, HDMI, etc.), an audio output device (e.g., speakers, a port that can carry audio information such as a microphone jack, USB, HDMI, etc.), a vibration device and/or any other device by which information can be formatted for output or actually outputted by a user or operator of the authentication device 300. For example, if the authentication device 300 corresponds to the authentication device 200A as shown in FIG. 2A, the user interface output circuitry configured to present information 320 can include the display as illustrated in FIG. 2A. The user interface output circuitry configured to present information 320 can also include software that, when executed, permits the associated hardware of the user interface output circuitry configured to present information 320 to perform the presentation function(s) associated therewith. However, the user interface output circuitry configured to present information 320 does not correspond to software alone, and the user interface output circuitry configured to present information 320 relies at least in part upon structural hardware to achieve the functionality associated therewith.

Referring to FIG. 3, the authentication device 300 further includes authentication detection circuitry 325. In an example, the authentication detection circuitry 325 can be part of existing circuitry (e.g. a processor, camera, etc.) that work cooperatively with dedicated software to perform the authentication code scanning/detection functionally. Alternatively, authentication detection circuitry 325 can be a dedicated device such as an RF-ID scanner, laser scanner, etc. which may rely at least in part upon structural hardware described herein to achieve the functionality associated therewith.

Referring to FIG. 3, while the structural components 305 through 325 are shown as separate or distinct blocks in FIG. 3, those skilled in the art will appreciate that the various structural components 305 through 325 may be coupled to one another via an associated communication bus (not shown) and further that the hardware and/or software through which the respective structural components 305 through 325 perform the respective functionality associated therewith can overlap in part. For example, any software used to facilitate the functionality associated with the structural components 305 through 325 can be stored in the non-transitory memory associated with the memory configured to store information 315, such that the configured structural components 305 through 325 each perform the respective functionality associated therewith (i.e., in this case, software execution) based in part upon the operation of the software stored in the memory configured to store information 315. Likewise, hardware that is directly associated with one of the structural components 305 through 325 can be borrowed or used by other structural components 305 through 325 from time to time.

Accordingly, those skilled in the art will appreciate that the various structural components 305 through 325 as shown in FIG. 3 are intended to invoke an aspect that is at least partially implemented with structural hardware, and are not intended to map to software-only implementations that are independent of hardware and/or non-structural (e.g., purely functional) interpretations. Furthermore, those skilled in the art will appreciate other interactions or cooperation between the structural components 305 through 325. For example, it will be appreciated that the functional aspects disclosed herein may be integrated into various application specific devices, such as inventory control devices, which can be used in the distributor authentication. In other aspects, the functional aspects disclosed herein may be integrated into smart credit cards and used to as an additional layer of security for the transaction, so the purchaser knows that the purchase is from an authorized retailer.

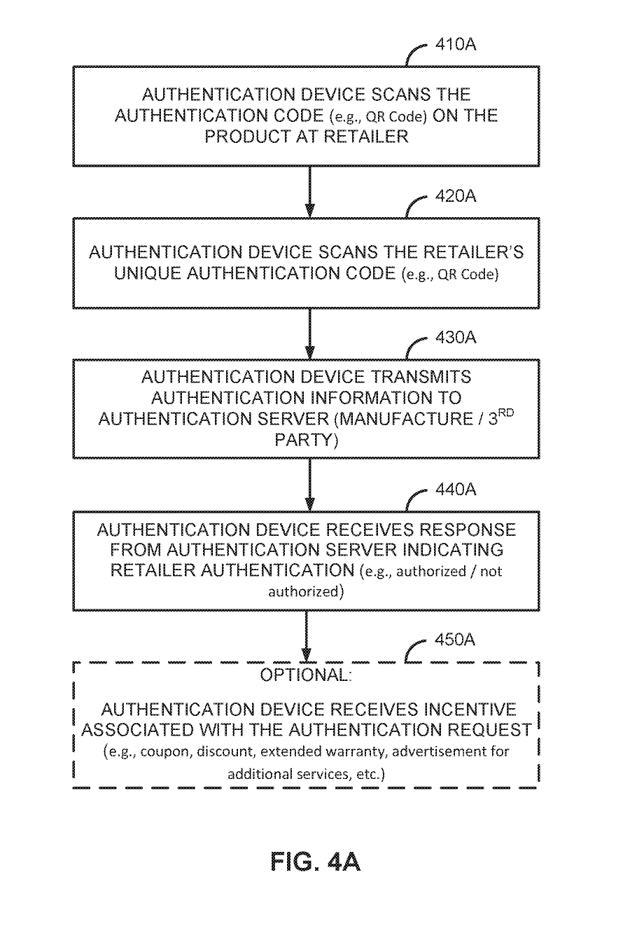

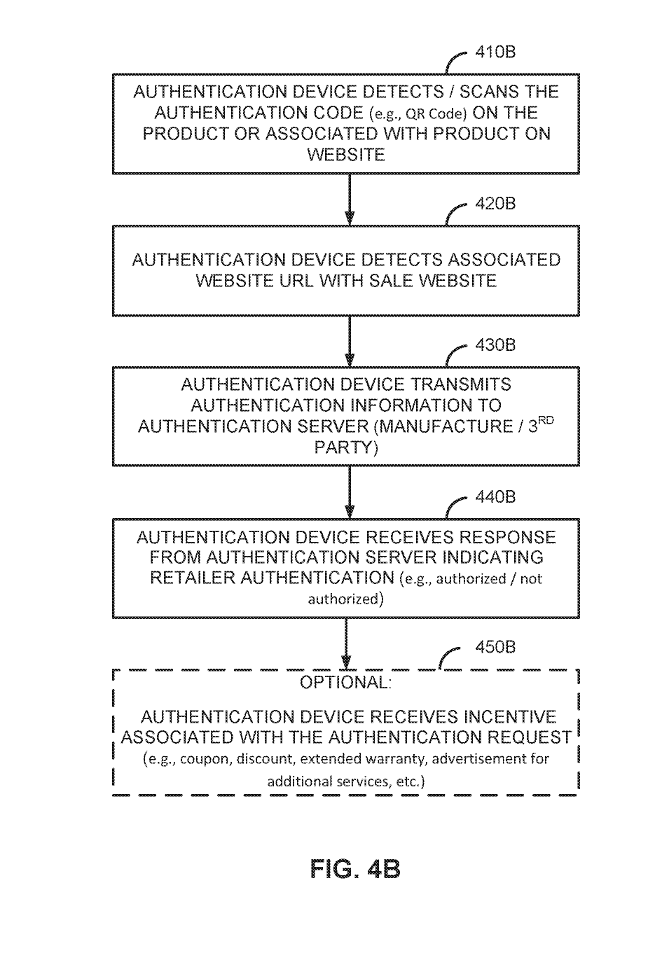

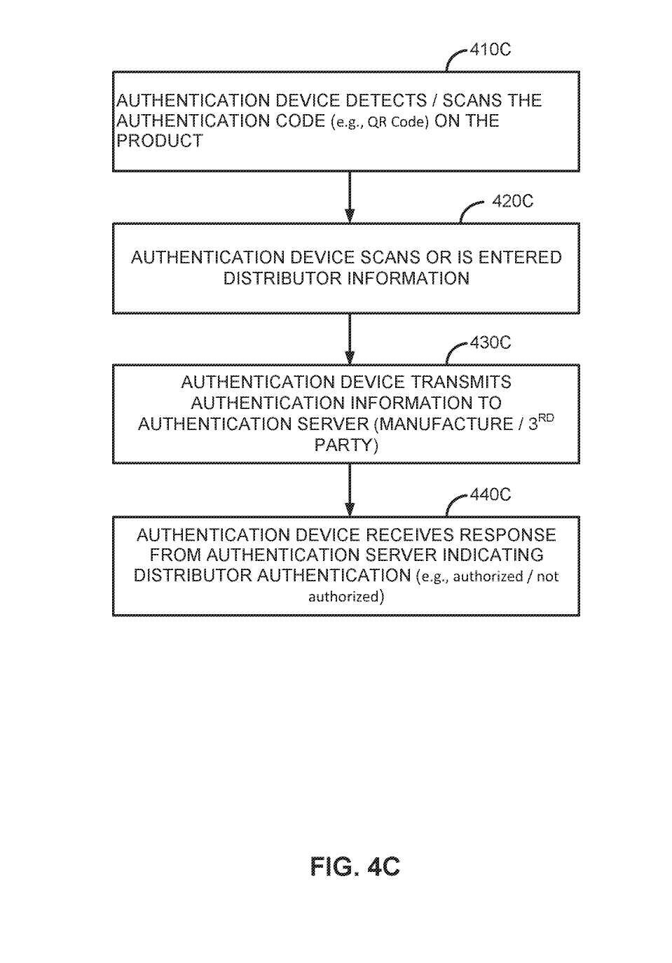

FIG. 4A is an illustration of a flowchart for a retail implementation. In block 410A, the authentication device scans the authentication code (e.g., QR code, bar code, RFID tag, etc.) on the product at the retailer. In block 420A, the authentication device scans the retailer's unique authentication code. As discussed above the scanning and code are to be broadly construed for both the retailer code and the authentication code. In block 430A, the authentication device transmits authentication information to an authentication server. As discussed above, the authentication information is not solely limited to the authentication code and/or retailer code. In block 440A, the authentication device receives a response from authentication server indicating the retailer authentication (e.g., authorized or not authorized). Optionally, as noted in 450A, the authentication device can receive an incentive along with the response or as a subsequent communication. The incentive can be provided by the manufacturer and/or a third party and can be one or more of a coupon, discount, extended warranty, advertisement for additional services, etc.

FIG. 4B is an illustration of a flowchart for an online implementation. In block 410B, the authentication device scans the authentication code on, or associated with, the product at the online retailer. In block 420B, the authentication device scans/detects the online retailer's unique authentication code. As discussed above the scanning and code are to be broadly construed for both the retailer code and the authentication code. For example, in the online context, the website URL may be used as the retailer code. In block 430B, the authentication device transmits authentication information to an authentication server. As discussed above, the authentication information is not solely limited to the authentication code and/or retailer code. In block 440B, the authentication device receives a response from authentication server indicating the retailer authentication (e.g., authorized or not authorized). Optionally, as noted in 450B, the authentication device can receive an incentive along with the response or as a subsequent communication. The incentive can be provided by the manufacturer and/or a third party and can be one or more of a coupon, discount, extended warranty, advertisement for additional services, etc.

FIG. 4C is an illustration of a flowchart for a distribution implementation. In block 410C, the authentication device scans the authentication code on, or associated with, the product or distribution packaging at the retailer when the product is received. In block 420C, the authentication device scans/detects/enters the online distributor's unique authentication code and/or distributor information. As discussed above the scanning and code are to be broadly construed for both the distributor code and the authentication code. In block 430C, the authentication device transmits authentication information to an authentication server. As discussed above, the authentication information is not solely limited to the authentication code and/or distributor code. In block 440C, the authentication device receives a response from the authentication server indicating the distributor authentication (e.g., authorized or not authorized).

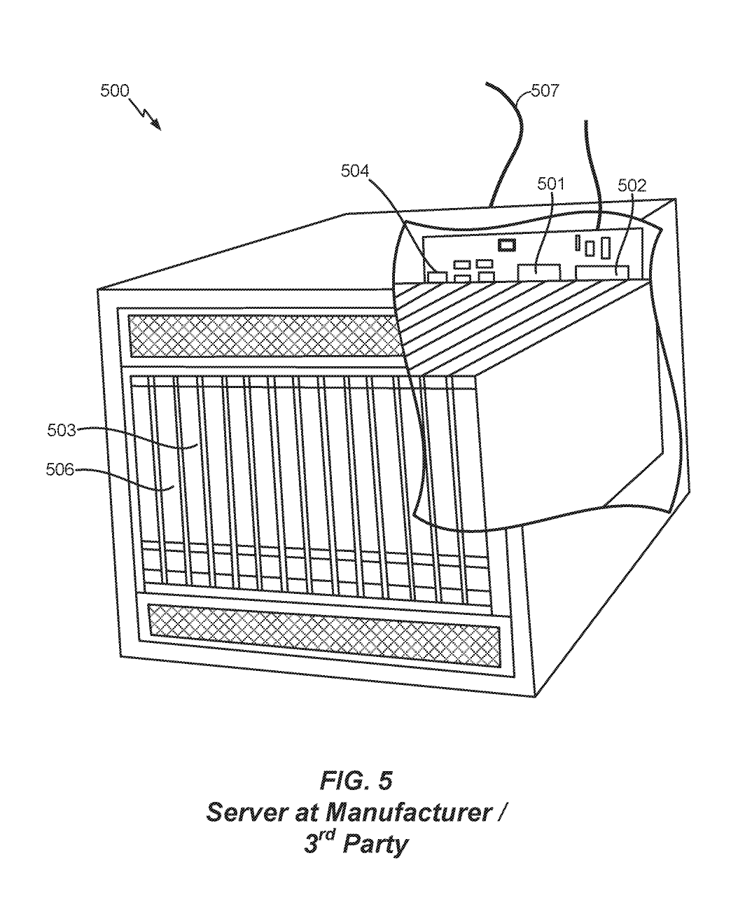

The various aspects and embodiments described herein may be implemented on any of a variety of commercially available server devices, including an authentication server 500 as illustrated in FIG. 5. In an example, the authentication server 500 may correspond to one example configuration of the manufacturer server 170 and/or third (3^{rd}) party server 160, described above. In FIG. 5, the authentication server 500 includes a processor 501 coupled to volatile memory 502 and a large capacity nonvolatile memory 503 (e.g., a hard disk). The authentication server 500 may also include a floppy disk drive, a compact disk (CD) drive, and/or a DVD disk drive 506 coupled to the processor 501. The authentication server 500 may also include network access ports 504 coupled to the processor 501 for establishing data connections with a network 507, such as a local area network coupled to other broadcast system computers and servers or to the Internet. Optional user interface output circuitry configured to present information and the optional user interface input circuitry configured to receive local user input are not shown explicitly in FIG. 5 and may or may not be included therein. Additionally, as noted above, the authentication server 500 may be implemented in one or more physical servers working in combination.

Regardless of the implementation details, the authentication server 500 is configured to receive the authentication information from the authentication device. As discussed above, the authentication information is not solely limited to the authentication code and/or retailer code. The authentication server 500 processes the authentication information and provides a response to the authentication device indicating the retailer/distributor authentication (e.g., authorized or not authorized). Optionally, as discussed above, the authentication server 500 can be configured to transmit an incentive along with the response or in a subsequent communication. The incentive can be provided to a third party that may be initiated by a communication from the authentication to the third party server 160. The incentive can be one or more of a coupon, discount, extended warranty, advertisement for additional services, etc. or anything else that would provide an incentive for the purchaser to participate in the authentication process. The server can also aggregate all the various authentication information from the various transactions as a way to derive further information regarding the purchasing patterns and distribution chain integrity.

In one aspect, for example, even if the server is not receiving distribution chain information, the server can use the crowd sourcing information from various purchases to try and focus resources on specific geographic areas, suppliers, etc. that may be useful for identifying problems with the distribution chain and/or retailers. For example, knowing a particular retailer is selling more product than it is legitimately being provided from a manufacturer would indicate that there are problems with the distribution chain and/or retailer. For example, an authorized retailer may be getting counterfeit products from unauthorized distributors and/or authorized distributors. Likewise, if a manufacturer server/third party authentication server receives a significant amount of authentication requests from unauthorized retailers in a particular area, it could indicate that a distributor supplying that area is providing product to unauthorized retailers. In either case, it could allow the manufacturer to focus its investigation and enforcement efforts to the most problematic areas and/or retailers. Further, the data collected regarding the purchases or even the interest in purchasing (assuming the purchase is not completed) could be used in many other aspects. For example, the purchasing/purchasing interest in an area without authorized retailers may be used by a manufacturer to invest in establishing authorized retailers and/or distributors in a particular area. In another aspect, the purchasing information can be used by licensors as a check that their licensees are complying with the terms of the license. For example, if more product is being sold than licenses are purchased, the authentication information can indicate both a loss of licensing revenue and also point to specific manufacturers, areas and/or retailers that are the source of the loss.

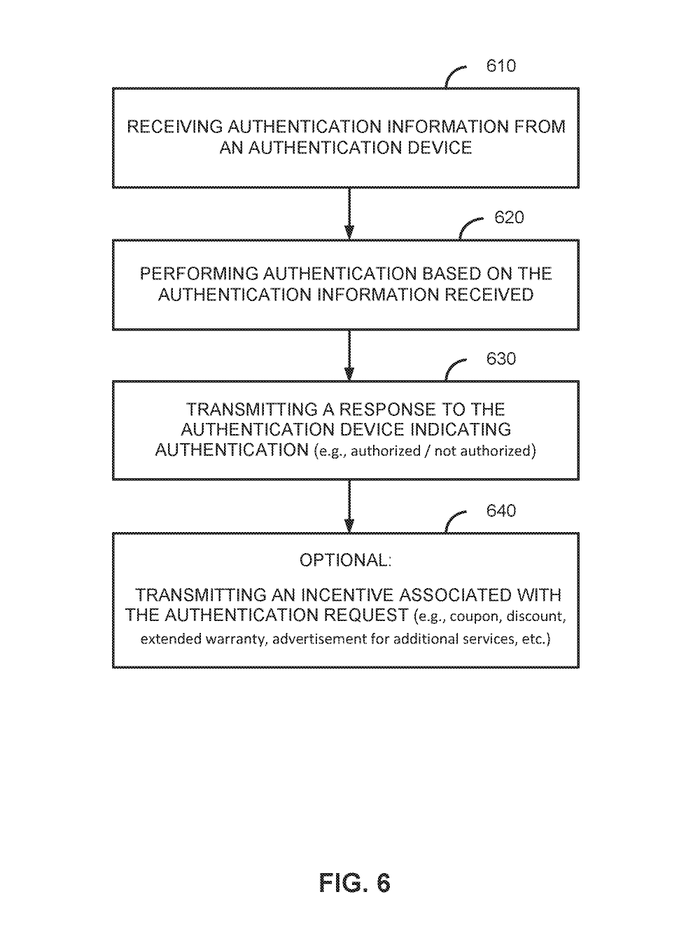

As will be appreciated from the foregoing, in one aspect a method for performing the authentication at a server is illustrated in FIG. 6. In block 610, the server can receive the authentication information from an authentication device. In block 620, the server can perform an authentication based on the authentication information from the authentication device. It will be appreciated that the server may also use additional information, such as public and private databases to provide additional levels of confidence in the authentication decision, particularly in the case where the authentication information may be incomplete or in doubt. For example, the authentication code may be accurate, but the retailer code may be unavailable or questionable. The server could use location information, if included with the authentication information, to verify the retailer by looking up public and/or private information to identify the retailer at the location reported. Further, the location information, IP address, visible access points, etc. (which may be optionally included in the authentication information) could also be used by the server to confirm that the retailer code (even if legitimate) is associated with the actual retailer. This would help to prevent the counterfeiting of retailer codes. Many other variations of the authentication process can be practiced depending on the information contained in the authentication information. However, regardless of the specific authentication process used, once the server has made a decision, the response indicating authentication (e.g., authorized/not authorized) can be sent to the authentication device, in block 630. Optionally, in block 640, the server (or other device) can also transmit an incentive (or multiple incentives) to the authentication device. It will be appreciated that the server discussed herein can be a manufacturer server, a third party server and/or any combination thereof. Further, although discussed and illustrated as one device, it will be appreciated that the functionality of the server can be distributed over multiple devices which may be local or remote to each other.

In relation to the distribution chain being verified for legitimate product, the authentication process can be further used to provide verification of specific aspects of the product being sold. For example, the authentication may include verifying the origin of the product being sold (e.g., made in the USA) or that it complies with certain aspects not directly apparent that may be important to a consumer (e.g., sustainable harvesting, animal testing free, etc.). This could be inherent in the authentication (e.g., the product/manufacture is known to comply) and/or it could also be part of the incentive information provided (e.g., an advertisement/communication that would indicate the compliance, origin, etc.). The latter aspect could be a valuable tool for consumers that may be looking to purchase new products from manufacturers that they are unfamiliar with. For example, a consumer trying out new perfume may wish to ensure that the manufacturer did not participate in animal testing. In addition to helping the consumer make an informed decision, it could help expand the manufacturer's potential market. This incentive information could be provided by the manufacturer or could be provided by a third party monitor that would confirm compliance. For example, a manufacturer could, based on the authentication information, communicate with a third party server of a relevant organization to pass along its advertisement/information to the authentication device.

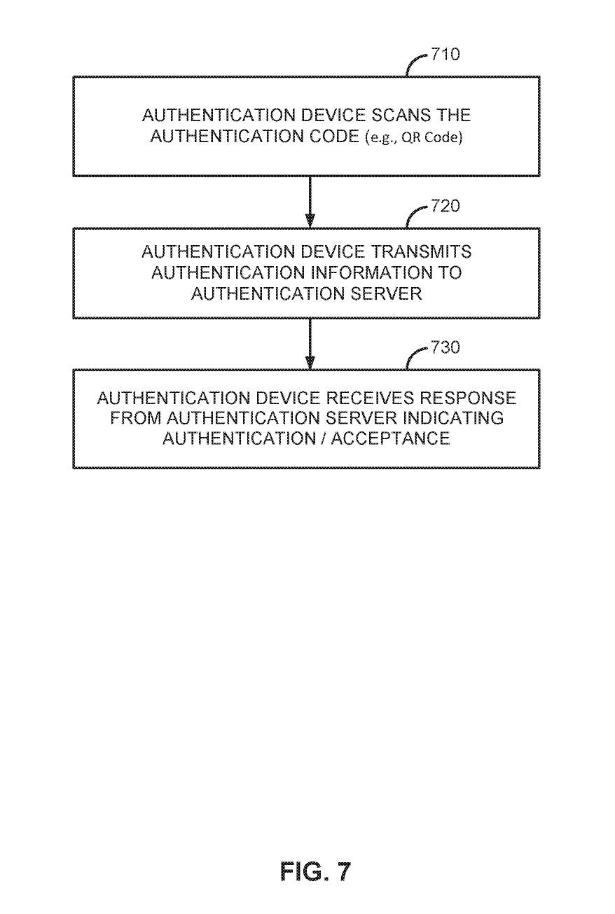

In another aspect consistent with the disclosed embodiments, the authentication process can be used to ensure vote integrity. For example, referring to FIG. 7, in 710, a voter may use an authentication device (e.g., Smartphone, dedicated device, etc.) to scan an authentication code published by an authorized ballot distribution authority (e.g., state, county, city, precinct, corporation, brokerage firm, etc.) that is part of the ballot or at least closely associated with the ballot (e.g., located on an envelope to be sealed). The authentication device can then transmit the authentication information to the authentication server, in 720. For example, once the ballot has been sealed in the return envelope the authentication code could be scanned and authentication information can be transmitted to the authentication server, which may reside with the authorized ballot distribution authority or may be referred to another party (e.g., a centralized voter integrity system). In addition to the authentication code additional information may be provided with the authentication information that may aid in detecting fraud and/or processing the ballot. For example, information about the authentication device (e.g., SIM data, phone number, etc.) may be used to ensure that the authentication device is associated with the voter). Additionally, the actual ballot responses could optionally be transferred as part of the authentication information. After the authentication server processed the authentication information (discussed in greater detail below) the authentication device can receive an indication that the authentication information was accepted (e.g., confirmation of voter as being registered as having voted), in 730.

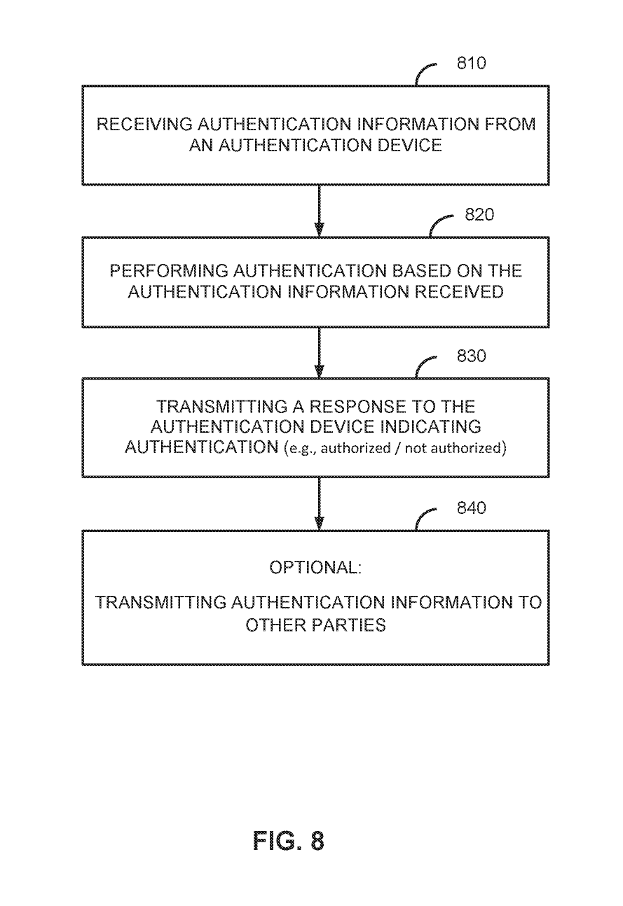

As will be appreciated from the foregoing, in one aspect a method for performing the authentication at a server is illustrated in FIG. 8. In block 810, the server can receive the authentication information from an authentication device. In block 820, the server can perform an authentication based on the authentication information from the authentication device. It will be appreciated that the server may also use additional information, such as public and private databases to provide additional levels of confidence in the authentication decision. For example, once received, the authentication server can confirm the code and associated ballot is valid (e.g., was distributed by an authorized ballot distribution authority), optionally can perform additional fraud checks/verification of the authentication device's association with intended voter and/or register any actual ballot/voting information received. Regardless of the specific authentication process used, once the authentication server has made a decision, the response indicating authentication (e.g., register the associated voter as having voted) can be sent to the authentication device, in block 830. Optionally, in block 840, the authentication server (or other device) can also transmit the authentication information (e.g., vote acceptance) to other parties (e.g., other voting jurisdictions, poll workers, etc. to prevent any further voting associated with that voter (e.g., an absentee ballot has been registered as being voted, so the voter would be flagged and would not be issued a ballot at an in person polling location. It will be appreciated that the server discussed herein may reside with the authorized ballot distribution authority or may be located with another party (e.g., a centralized voter integrity system, other government entity, etc.). Further, although discussed and illustrated as one device, it will be appreciated that the functionality of the authentication server can be distributed over multiple devices which may be local or remote to each other.

Those skilled in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those skilled in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted to depart from the scope of the various aspects and embodiments described herein.

The various illustrative logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration).

The methods, sequences and/or algorithms described in connection with the aspects disclosed herein may be embodied directly in hardware, in a software module executed by a processor, or in a combination of the two. A software module may reside in RAM, flash memory, ROM, EPROM, EEPROM, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in the authentication device.

In one or more exemplary aspects, the functions described herein may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, DSL, or wireless technologies such as infrared, radio, and microwave, then the coaxial cable, fiber optic cable, twisted pair, DSL, or wireless technologies such as infrared, radio, and microwave are included in the definition of a medium. The term disk and disc, which may be used interchangeably herein, includes CD, laser disc, optical disc, DVD, floppy disk, and Blu-ray discs, which usually reproduce data magnetically and/or optically with lasers. Combinations of the above should also be included within the scope of computer-readable media.

While the foregoing disclosure shows illustrative aspects and embodiments, those skilled in the art will appreciate that various changes and modifications could be made herein without departing from the scope of the disclosure as defined by the appended claims. The functions, steps and/or actions of the method claims in accordance with the aspects and embodiments described herein need not be performed in any particular order. Furthermore, although elements may be described above or claimed in the singular, the plural is contemplated unless limitation to the singular is explicitly stated.

What is claimed is:

1. A method for authentication of a retailer at a place of purchase, comprising:
scanning an authentication code on a product at the retailer;
obtaining a retailer code to identify the retailer;
transmitting authentication information including at least one of the authentication code or the retailer code to an authentication server; and
receiving a response from the authentication server indicating the retailer authentication.

2. The method recited in claim 1, wherein the authentication code is at least one of a QR code, a bar code or a radio frequency identification (RFID) code.

3. The method recited in claim 1, wherein the authentication server is a server of at least one of a manufacturer of the product or a third party.

4. The method recited in claim 1, wherein the response from the authentication server indicates that the retailer is either authorized or not authorized.

5. The method recited in claim 1, further comprising:
receiving an incentive along with the response the authentication server.

6. The method recited in claim 5, wherein the incentive is at least one of a coupon, a discount, an extended warranty, or an advertisement for additional services or products.

7. The method recited in claim 1, wherein the retailer is an online retailer and the retailer code is a website Uniform Resource Locator (URL) associated with the online retailer.

8. An apparatus, for authentication of a retailer at a place of purchase, comprising:
means for scanning an authentication code on a product at the retailer;
means for obtaining a retailer code to identify the retailer;
means for transmitting authentication information including at least one of the authentication code or the retailer code to an authentication server; and
means for receiving a response from the authentication server indicating the retailer authentication.

9. The apparatus of claim 8, wherein the authentication code is at least one of a QR code, a bar code or a radio frequency identification (RFID) code.

10. The apparatus of claim 8, wherein the authentication server is a server of at least one of a manufacturer of the product or a third party.

11. The apparatus of claim 8, wherein the response from the authentication server indicates that the retailer is either authorized or not authorized.

12. The apparatus of claim 8, further comprising:
means for receiving an incentive along with the response the authentication server.

13. The apparatus of claim 12, wherein the incentive is at least one of a coupon, a discount, an extended warranty, or an advertisement for additional services or products.

14. The apparatus of claim 8, wherein the retailer is an online retailer and the retailer code is a website Uniform Resource Locator (URL) associated with the online retailer.

15. A non-transitory computer-readable storage medium having computer-executable instructions recorded thereon, wherein executing the computer-executable instructions for authentication of a retailer at a place of purchase on one or more processors causes the one or more processors to:
scan an authentication code on a product at the retailer;
obtain a retailer code to identify the retailer;
transmit authentication information including at least one of the authentication code or the retailer code to an authentication server; and
receive a response from the authentication server indicating the retailer authentication.

16. The non-transitory computer-readable storage medium of claim 15, wherein the authentication code is at least one of a QR code, a bar code or a radio frequency identification (RFID) code.

17. The non-transitory computer-readable storage medium of claim 15, wherein the authentication server is a server of at least one of a manufacturer of the product or a third party.

18. The non-transitory computer-readable storage medium of claim 15, further comprising one or more computer-executable instructions that causes the one or more processors causes to:
receive an incentive along with the response the authentication server.

19. The non-transitory computer-readable storage medium of claim 18, wherein the incentive is at least one of a coupon, a discount, an extended warranty, or an advertisement for additional services or products.

20. The non-transitory computer-readable storage medium of claim 15, wherein the retailer is an online retailer and the retailer code is a website Uniform Resource Locator (URL) associated with the online retailer.
